(19) United States
(12) Patent Application Publication
(10) Pub. No.: US 2011/0108568 A1
(43) Pub. Date: May 12, 2011

(54) SYSTEM AND METHOD OF COMPARING TWO MATERIALS WITHIN A MATERIAL DISTRIBUTION SYSTEM

(76) Inventor: Jeremiah Hogan, Richardson, TX (US)

(21) Appl. No.: 12/615,451

(22) Filed: Nov. 10, 2009

(51) Int. Cl. B67D 7/00

(52) U.S. Cl. 222/1; 222/25; 222/52

(57) ABSTRACT

A controller for use in a material dispensing system having a first material inlet, a second material inlet, a distribution outlet, a first material container and a second material container. The first material container has a first container parameter and can contain an amount of a first material. The second material container has a second container parameter and can contain an amount of a second material. The first material container can provide the first material to the first material inlet, whereas the second material container can provide the second material to the second material inlet. The controller includes a device and an output device. The device is arranged to receive the first material and to receive the second material. The device can provide a first signal based on the first material and can provide a second signal based on the second material. The output device can provide an output signal based on the first signal and the second signal.

### BACKGROUND

Materials such as gases and liquids in containers may be connected to material dispensing systems (MDS) for use in a variety of applications. Ensuring that the proper material is connected to the MDS may be important, as allowing the wrong material to enter an MDS may cause damage to the system itself, and/or a downstream system or application that may utilize the material provided by the MDS.

In some applications, it may be arranged such that the MDS utilizes a two-container system, wherein two containers may be connected to the MDS in a manner so that one container may be in-use, while another container may be in standby. The standby container may be kept in a ready state to be utilized when the in-use container is approaching empty. The MDS may determine that the in-use container is near empty and may then switch over to the standby container in order to ensure an uninterrupted supply of material to the MDS. When the switch is complete, the system may notify an operator of the system that one of the containers needs to be replaced with a full container. The operator may then disconnect the near empty container and install a full container in its place. The container that was formerly in standby mode may now be the in-use container. The container that was most recently connected may then be considered the standby container. One such conventional MDS will now be described with reference to FIG. 1.

FIG. 1 illustrates an example conventional MDS 100.

As illustrated in the figure, MDS 100 includes an enclosure 104, a controller portion 101, a purge inlet 108, an exhaust 112 and a distribution line 110. Enclosure 104 further includes a sensor 114, a sensor 116, a pigtail 126, a pigtail 128, a container 118, a container 120, a container valve 122 and a container valve 124.

Sensor 114 is associated with container 118, whereas sensor 116 is associated with container 120. Container valve 122 is connected to container 118, whereas container valve 124 is connected to container 120. Pigtail 126 is arranged between container valve 122 and controller portion 101, whereas pigtail 128 is arranged between container valve 124 and controller portion 101. Purge inlet 108 is arranged to connect controller portion 101 to a source of purging material (not shown). Exhaust 112 is arranged to connect controller portion 101 to a material exhaust system (not shown). Distribution line 110 is arranged to connect controller portion 101 to a material distribution system (not shown). A material distribution system may be a system of piping, valves, controllers, and/or other devices for distributing material from an MDS. A material distribution system may take material from an MDS and supply it to components, tools, machinery, and the like for a variety of uses.

Container 118 and container 120 hold material to be dispensed via MDS 100. Valve 122 may be opened to allow material to flow from container 118, through pigtail 126, into controller portion 101, or closed to prevent the flow of material. Valve 124 may be opened to allow material to flow from container 120, through pigtail 128, into controller portion 101, or closed to prevent the flow of material. Sensor 114 is operable to measure the amount of material in container 118. Sensor 114 may be a scale to measure the weight of container 118. Similarly, sensor 116 is operable to measure the amount of material in container 120. Sensor 116 may be a scale to measure the weight of cylinder 120.

Enclosure 104 houses container 118, container 120, sensor 114, sensor 116, pigtail 126 and pigtail 128. Controller portion 101 may sit atop enclosure 104. Distribution line 110 allows material flowing from controller portion 101 on to the system that is being supplied material by MDS 100. Purge inlet 108 connects controller portion 101 to a supply of material for purging the piping (not shown) and components of controller portion 101. Exhaust 112 connects controller portion 101 to an appropriate exhaust system (not shown) for disposing of waste products from controller portion 101.

Operation of a conventional MDS 100 will now be discussed with reference to FIG. 2.

FIG. 2 is a flowchart describing an example process 200 of operating MDS 100.

Process 200 starts (S202), and an initial parameter is set (S204). Initial parameters may include a usable material parameter to determine whether the amount of material contained in an in-use container is sufficient for its continued use.

For example, in the case where sensor 114 includes a scale, the usable material parameter may be a lower weight threshold. In such a case, for example, when sensor 114 determines that the weight of container 118 falls below the lower weight threshold, it may be determined that container 118 is nearly out of the usable material.

The parameter may be set, for example, to a minimum weight that indicates that container 118 still has some useable material, but that it is at a level of material that suggests that it will be near empty soon. This may be done to prevent an undesirable condition, such as a container becoming completely empty, as this condition may allow contamination to enter into MDS 100. Alternatively, this undesirable condition may result in a disruption of a downstream system supplied by MDS 100, due to loss of flow of material from MDS 100.

Parameters may be set by an operator of MDS 100 or programmed into controller portion 101 by other known ways. For this example, consider container 118 to be the in-use container.

The material in container 118 is then accessed by opening valve 122 (S206). Material enters pigtail 126 and flows to controller portion 101.

Controller portion 101 may draw material from container 118. Controller portion 101 may draw material from container 118 by opening valves, mass flow controllers, relays, or other known methods.

A parameter may then be measured to determine the amount of material in container 118 (S208). For example, in the case where sensor 114 includes a scale, sensor 114 may determine the weight of the container and provide the information to controller portion 101.

It is then determined whether container 118 is near empty (S210).

If it is determined that container 118 is not near empty, process 200 may continue to deliver material from the in-use container, in this example, container 118 (S212). The parameter is again measured (S208), and process 200 continues accordingly.

If, however, it is determined in step S208 that container 118 is near empty, an operator of MDS 100 may be notified (S214). Notification of the system operator may be by one of audible alarm, indicator light or any other known notification system (not shown).

Material supply may then be switched from the in-use container, container 118 to the standby container, container 120 (S216). Container 120 may then be considered the in-use container.

The near empty container 118 may then be replaced with a full container (S218). For example, valve 122 may be closed and pigtail 126 may then be disconnected from near empty container 118. Near empty container 118 may be removed, and a full container may be placed on sensor 114. Pigtail 126 may then be connected to the new container. Valve 122 of the new container may then be re-opened.

A purge procedure may then be performed (S219). A purge procedure may remove unwanted materials such as air that may have entered pigtail 126 during the process of switching out the near empty container. The purge procedure may be a cyclic procedure of evacuating the pigtail, purging the pigtail with a supply of purge material (not shown) a number of times, followed by allowing a quantity of the material in the new container to flow into the pigtail to pre-populate the line with material. Controller portion 101 may conduct the purge procedure by appropriate manipulation of components of controller portion 101.

Process 200 may therein enable MDS 100 to provide an uninterrupted supply of material to the downstream material distribution system (not shown).

Process 200 may terminate (S220) if controller portion 101 determines that one or more error conditions exist. In addition, process 200 may be manually terminated by an operator of MDS 100.

There may be instances wherein the wrong container may become connected to MDS 100 during the switching procedure (S216). It is also possible that the wrong material may have been put into a container, or a container may have been mislabeled, thereby establishing other conditions wherein the wrong material may become connected to MDS 100.

There may also be a situation wherein system interlocks and/or protection methods may be overridden, and thereby inadvertent or deliberate connection of the wrong material to MDS 100 may be facilitated. There may be other situations wherein the wrong material may be connected to MDS 100, and thereby contamination of the system may result. This may lead to damage to MDS 100, contamination of downstream systems utilizing the material from MDS 100, or other negative outcome resulting from the connection and/or distribution of incorrect material into MDS 100.

In these and similar systems, certain procedures, protocols, interlocks, and/or special connections may be employed in order to maximize the likelihood that containers being connected to an MDS are the correct containers with the correct material in them. Despite numerous systems and methods of ensuring that the proper container with the proper material is connected, it may still happen that the wrong container or the correct container having the wrong material therein may become connected to an MDS. When this occurs, the MDS and/or downstream systems served by the MDS may become contaminated, damaged, and/or destroyed. This can lead to costly cleaning, repair work, tool damage, product loss, process damage, safety hazards, and/or other negative outcomes.

What is needed is a system and method to decrease the likelihood of the wrong material from being introduced into an MDS.

### BRIEF SUMMARY

It is an object of the present invention to provide a system and method to decrease the likelihood of the wrong material from being introduced into a material distribution system by an MDS.

In accordance with an aspect of the present invention, a controller is provided for use in a material dispensing system having a first material inlet, a second material inlet, a distribution outlet, a first material container and a second material container. The first material container has a first container parameter and can contain an amount of a first material. The second material container has a second container parameter and can contain an amount of a second material. The first material container can provide the first material to the first material inlet, whereas the second material container can provide the second material to the second material inlet. The controller includes a device and an output device. The device is arranged to receive the first material and to receive the second material. The device can provide a first signal based on the first material and can provide a second signal based on the second material. The output device can provide an output signal based on the first signal and the second signal.

Additional objects, advantages and novel features of the invention are set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a conventional MDS;

FIG. 2 is a flowchart of an example conventional method of operating the MDS of FIG. 1;

FIG. 3 illustrates an example MDS in accordance with an aspect of the present invention;

FIG. 4 illustrates an example device for comparing materials, in accordance with an aspect of the present invention;

FIG. 5 illustrates an example device for comparing materials, in accordance with an aspect of the present invention;

FIG. 6A illustrates an example thermal conductivity detector in accordance with an aspect of the present invention;

FIG. 6B illustrates an example thermal conductivity detector in accordance with another aspect of the present invention;

FIG. 7 is a flowchart of an example method of operating the MDS of FIG. 3 in accordance with an aspect of the present invention.

### DETAILED DESCRIPTION

In accordance with an aspect of the present invention, a system and method are provided wherein a comparing device is incorporated into an MDS. The MDS may utilize a two-container system to maintain uninterrupted material supply of material to a material distribution system. When one container becomes sufficiently low, and a system operator replaces the depleted container with a full container, the MDS may arrange to allow material from the newly-replaced container to be introduced into a portion of a comparing device. The MDS may concurrently arrange to allow material from the in-use container to be introduced into another portion of the comparing device.

The comparing device of the MDS may determine whether or not the material in the new container is likely the same as the material currently in-use in the MDS by comparing a feature of the two materials, such as thermal conductivity. If the comparing device indicates that the material is likely the same, the controller may allow switching of the supply to the newly-installed container when the in-use container becomes sufficiently low. If the comparing device determines that the material in the newly-installed container is not the same as the material currently in-use in the MDS, it may notify the controller, by virtue of sending a signal to the controller. The controller may notify the system operator so that the container with the incorrect material should be removed before it contaminates the MDS. In this disclosure, the term comparing device may be used to describe a device and/or system that compares one material to another, or may compare one signal to another, as in comparing a device signal to a setpoint signal, or other comparison.

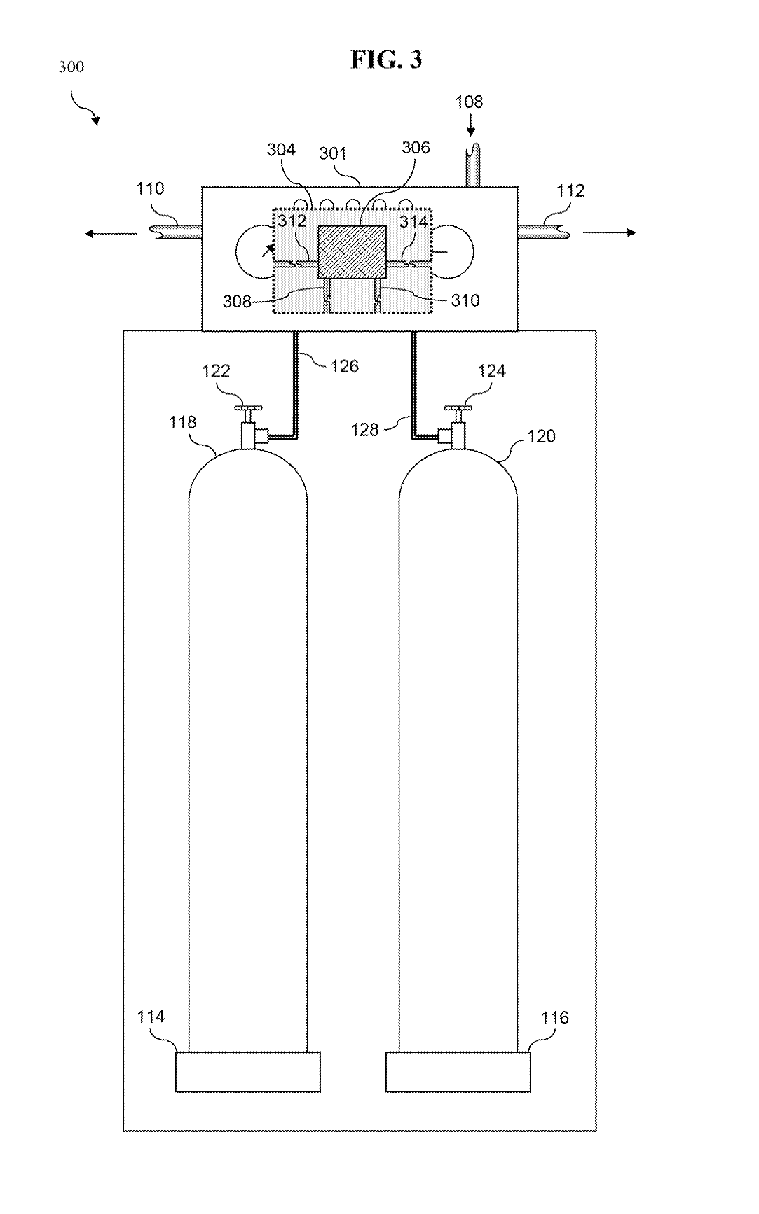

An example MDS in accordance with an aspect of the present invention will now be described with reference to FIGS. 3-5.

FIG. 3 illustrates an example MDS 300 in accordance with an aspect of the present invention.

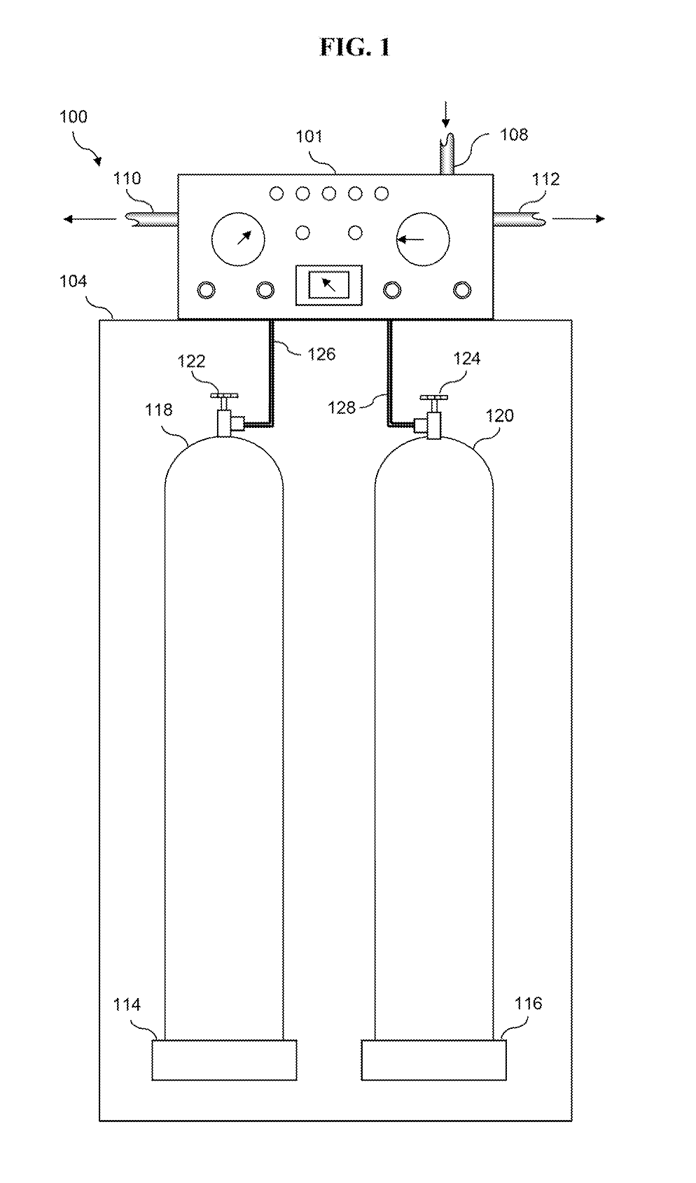

As illustrated in the figure, MDS 300 includes some of the same items of conventional MDS 100 of FIG. 1. However, controller portion 101 of conventional MDS 100 is replaced with controller portion 301 in MDS 300.

As seen in cutaway view 304, controller portion 301 includes a comparing device 306, an inlet 308, an inlet 310, an outlet 312 and an outlet 314.

Comparing device 306 is arranged to interface with controller portion 301 and may connect to material sources via inlet 308 and inlet 310, and to material outlets via outlet 312 and outlet 314. In addition, comparing device 306 may be interfaced to electronic monitoring and/or controlling components (not shown) within controller portion 301.

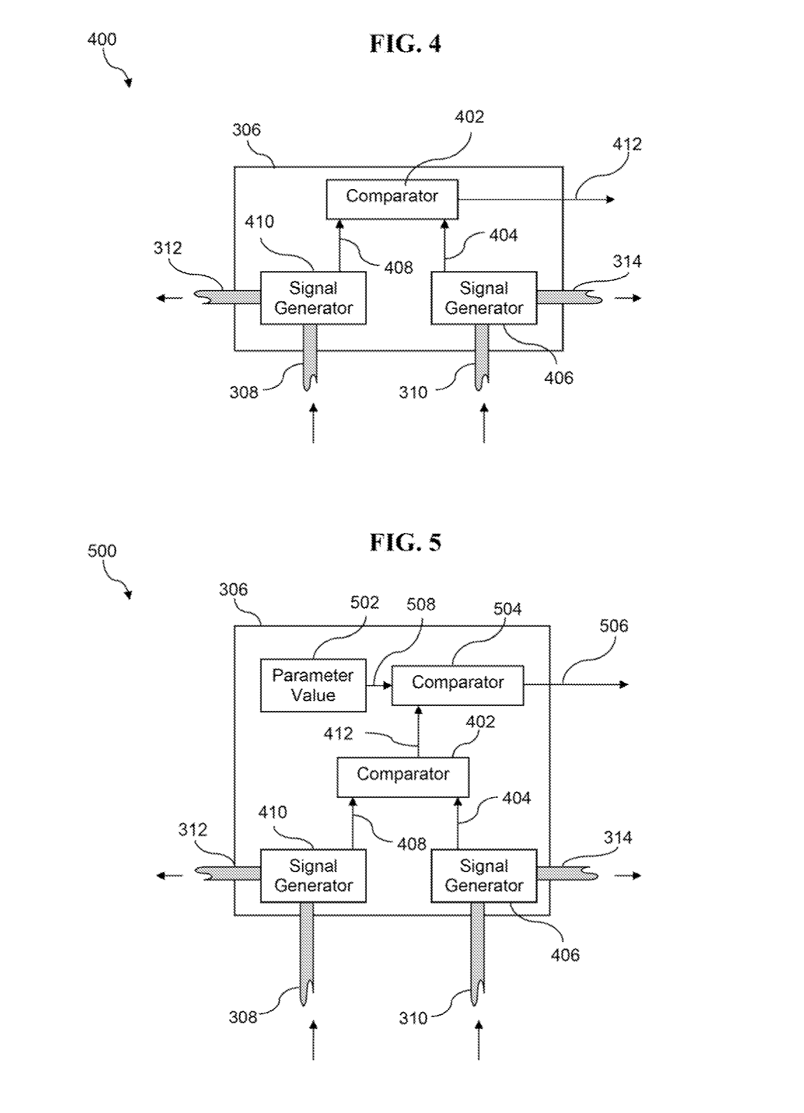

A more detailed discussion of an example comparing device 306, in accordance with an aspect of the present invention, will now be described with reference to FIG. 4.

As illustrated in FIG. 4, an example comparing device 306 of cutaway view 304 is described.

Comparing device 306 includes a signal generator 410, a signal generator 406 and a comparator 402. Signal generator 410 is arranged to receive material from container 118 by way of inlet 308, to output material by way of outlet 312 and to output a signal 408. Signal generator 406 is arranged to receive material from container 120 by way of inlet 310, to output material by way of outlet 314 and to output a signal 404. Comparator 402 is arranged to receive signal 408 and signal 404, to compare signal 408 with signal 404 and to output a signal 412 based on the comparison.

For purposes of discussion, presume in this example that container 118 is the in-use container, wherein material from container 118 may be allowed to flow through signal generator 410. Presume further that container 120 may be the newly connected container, and material from container 120 may be allowed to flow through signal generator 406. Signal generator 410 generates signal 408 based on a parameter of the material from container 118. Likewise, signal generator 406 generates signal 404 based on a parameter of the material from container 120.

If signal generator 410 is the same type of signal generator as signal generator 406, and if the material from container 118 is the same as the material from container 120, then signal 408 should be equal to signal 404. In such an event, signal 412 from comparator 402 will have a value equal to zero. Based on signal 412 having a zero value, controller portion 301 would recognize that the material in container 120 is likely the same material as that in container 118, and that the material in container 120 may be distributed via MDS 300 whenever container 118 is deemed sufficiently low. However, if signal 404 is different from signal 408, then signal 412 from comparator 402 will have a value greater than zero. In this case, based on signal 412 having a non-zero value, controller portion 301 would recognize that the material in container 120 is likely not the same material as that in container 118, and may indicate as much to the user.

There may be situations where signal generator 410 and signal generator 406 are not the same, for example as a result of manufacturing differences. In such cases, signal 408 and signal 404 may not be the same when the material from container 118 is the same as the material from container 120. To account for minor differences in signal generator 406 and signal generator 410, controller portion 301 may be designed to recognize that the material from container 118 is likely the same as the material from container 120 as long as signal 412 is below a predetermined threshold.

Further, there may be situations where the material from container 118 is the same as the material from container 120, but the material has a lightly variable property, e.g., a property the changes with temperature or pressure. In such situations, even if signal generator 410 and signal generator 406 are the same, signal 408 and 404 may not be the same. To account for minor differences in the material, controller portion 301 may be designed to recognize that the material from container 118 is likely the same as the material from container 120 as long as signal 412 is below a predetermined threshold.

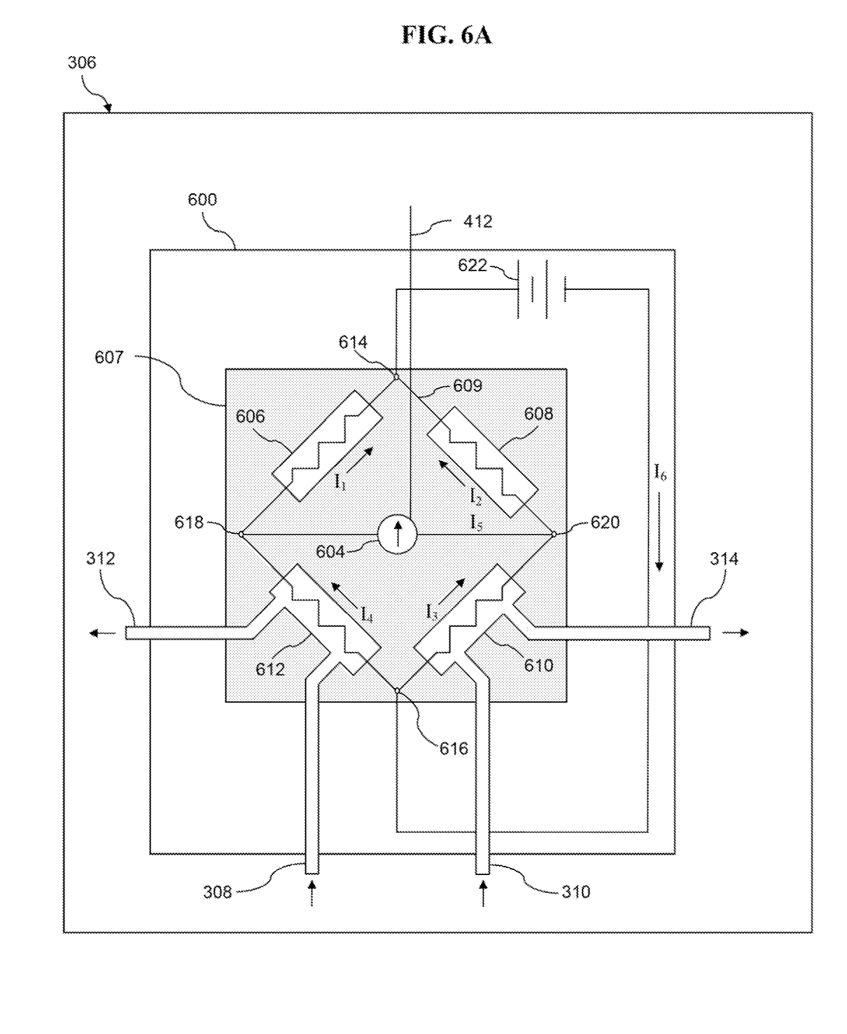

A more detailed discussion of an example comparing device 306 that can address the situations discussed directly above in accordance with an aspect of the present invention, will now be described with reference to FIG. 5.

FIG. 5 illustrates another example of comparing device 306 of cutaway view 304. This example comparing device 306 further includes a comparator 504 and a parameter value portion 502. Parameter value portion 502 is operable to generate a parameter value 508. Comparator 504 is arranged to receive parameter value 508 and signal 412 and to output a signal 506.

For purposes of discussion, presume that: 1) signal generator 410 and signal generator 406 are not the same, for example as a result of manufacturing differences; and/or 2) the material from container 118 is the same as the material from container 120, but the material has a lightly variable property. To account for minor differences in the material, comparing device 306 may be designed to recognize that the material from container 118 is likely the same as the material from container 120 as long as signal 412 is below a predetermined threshold. In particular, parameter value portion 502 may have a predetermined threshold parameter value 508 stored therein. Comparator 504 will determine whether the material from container 118 is likely the same as the material from container 120 based on a comparison of signal 412 with parameter value 508.

Presume that container 118 is the in-use container, wherein material from container 118 is allowed to flow through signal generator 410. Further presume that container 120 will be the newly connected container, and material from container 120 will be allowed to flow through signal generator 406. Signal 408 from signal generator 410 will be provided to comparator 402. Likewise, signal 404 from signal generator 406 will also be directed to comparator 402. Comparator 402 will then compare signal 408 and signal 404 and provide signal 412 to comparator 504. Comparator 504 will then compare signal 412 from comparator 402 with parameter value 508.

If signal 412 is less than or equal to parameter value 508, then signal 506 will indicate to controller portion 301 that the material in container 120 is likely the same as the material in container 118. In such a case, the material in container 120 may be distributed via an MDS 300 whenever container 118 is deemed near empty.

However, if signal 412 is greater than parameter value 508, then signal 506 will indicate to controller portion 301 that the material in container 120 is not likely the same as the material in container 118. In such a case, controller portion 301 may provide an indication to the user that the material in container 120 is not likely the same as the material in container 118.

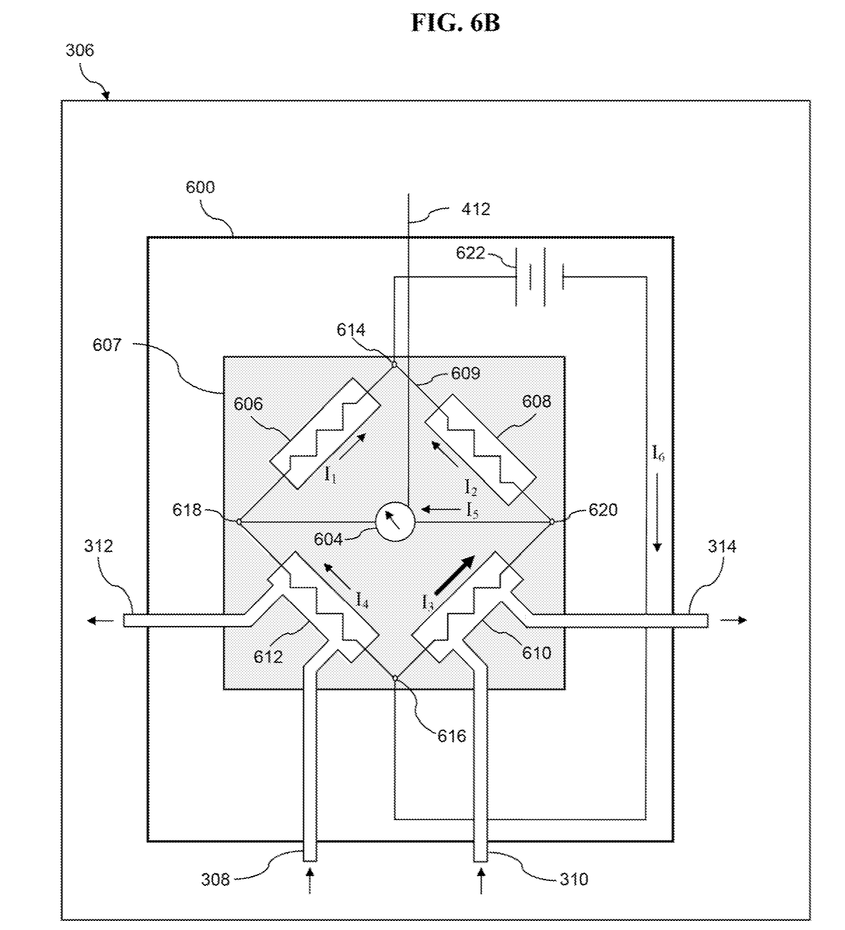

A specific example of comparing device 306 in accordance with an aspect of the present invention will now be described with reference to FIGS. 6A-6B.

In FIG. 6A, comparing device 306 includes a thermal conductivity detector 600. Thermal conductivity detector 600 includes a temperature-controlled block 607, inlet 308, inlet 310, outlet 312, outlet 314 and a circuit 609. Circuit 609 includes a meter 604, a resistor 606, a resistor 608, a resistor 610, a resistor 612 and a power supply 622.

Resistor 606, resistor 608, resistor 610 and resistor 612 are arranged in a Wheatstone Bridge configuration, as known to one skilled in the art. Specifically, resistor 606 is connected to resistor 612 and meter 604 at a connection 618 and is connected to resistor 608 and power supply 622 at a connection 614. Resistor 608 is additionally connected to resistor 610 and meter 604 at a connection 620. Resistor 610 is additionally connected to resistor 612 and power supply 622 at a connection 616. Meter 604 is operable to provide signal 412. Power supply 622 is operable to generate current I₆.

Inlet 310 and outlet 314 are arranged to provide material to/from resistor 610, respectively. Inlet 308 and outlet 312 are arranged to provide material to/from resistor 612, respectively.

In some embodiments, resistors 606, 608, 610 and 612 are mounted onto temperature-controlled block 607. Non-limiting example methods of mounting include adhesion with a heat-conducting material.

The temperature of resistor 610 and resistor 612 may be maintained at a stable temperature. In some embodiments, the temperature may be elevated above ambient temperature so as to be considered “heated.”

In an example embodiment, resistor 610 and resistor 612 are thermal resistors, or thermistors. Further, in some example embodiments, resistor 606 and/or resistor 608 may be variable resistors.

Operation of example comparing device 306 of FIG. 6A in a situation where the material provided by inlet 308 is the same as the material provided by inlet 310 will now be described.

For purposes of discussion, let: the current between connection 614 and connection 618 be I₁; the current between connection 614 and connection 620 be I₂; the current between connection 616 and connection 620 be considered I₃; the current between connection 616 and connection 618 be I₄; the current between connection 618 and connection 620, that is, at meter 604, be considered I₅.

Further, let the value of resistor 606 equal the value of resistor 608. Still further, let each of resistor 612 and resistor 610 have the same resistance value as a function of temperature. As such, since the material provided by inlet 308 is the same as the material provided by inlet 310, let the value of resistor 612 equal the value of resistor 610.

Under these conditions: current I₁ equals current I₂, current I₄ equals current I₃, and current I₅ is zero. Therefore, the output of meter 604, which is signal 412, is zero. This describes the balanced condition, i.e., the current is balance between two sides of the bridge of resistors.

Operation of example comparing device 306 in a situation where the material provided by inlet 310 is different from the material provided by inlet 308 will now be described with reference to FIG. 6B.

Subsequent to a purge procedure, controller portion 301 may enable components therein to allow material from container 118 to move across resistor 612 and to allow material from container 120 to move across resistor 610.

In this scenario, the difference in the materials in container 118 and container 120, as they move across resistor 612 and resistor 610 respectively, may induce a different temperature drop across the two resistors. For the purposes of explanation, presume that the difference in the materials in container 118 and container 120 result in the temperature of resistor 610 being less than the temperature of resistor 612. Further, in this example situation, presume that the decreased temperature of resistor 610 results in the resistance value of resistor 610 being less than the resistance value of resistor 612.

As shown in FIG. 6B, this difference in the temperature drop experienced by resistor 612 and resistor 610, which causes a change in resistance values, causes current I₃ across resistor 610 to increase. Because I₆ is fixed, the increase in current I₃ results in a decrease in current I₄ across resistor 612.

In this example, remember that the resistance value of resistor 606 is equal to the resistance value of resistor 608. Therefore, current I₁ across resistor 606 should remain equal to current I₂ across resistor 608. Through rudimentary current loop analysis, in this situation where current I₃ increases and current I₄ decrease, current I₅ will be induced across meter 604 in a direction from connection 620 to connection 618.

The magnitude of current I₅ is based on the difference of the resistance values of resistor 612 and resistor 610. The polarity of current I₅ determines which of resistor 612 and resistor 610 has the larger resistance value. In this example, if current I₅ is positive (flows in the direction from connection 620 to connection 618), then resistor 612 has a larger resistance value than resistor 610. Alternatively, in this example, if current I₅ is negative (flows in the direction from connection 618 to connection 620), then resistor 610 has a larger resistance value than resistor 612.

Meter 604 outputs signal 412 based on measured current I₅. In accordance with an aspect of the present invention, the magnitude of current I₅ indicates whether the resistance values of resistor 610 and resistor 612 differ. As discussed above, a difference in the resistance values of resistor 610 and resistor 612 directly results from the material in container 118 being different from the material in container 120. Accordingly, magnitude of I₅ provides enough information to determine that the material from container 118 differs from the material from container 120. In other words, the polarity of current I₅ is not required.

Controller portion 301 uses thermal conductivity detector 600 as the comparator 402 to compare two materials (a first material moving across resistor 610 from inlet 310 to outlet 314 and a second material moving across resistor 612 from inlet 308 to outlet 312) to determine whether the materials are likely to be the same.

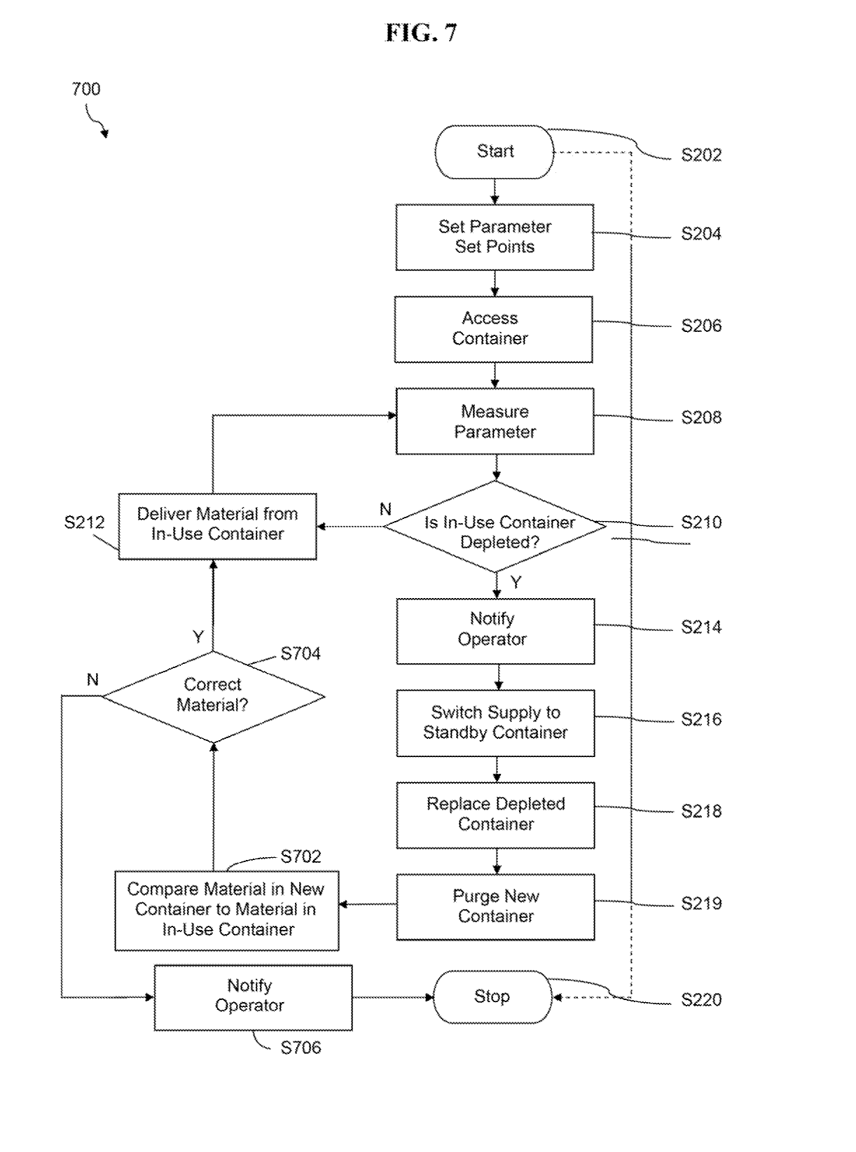

An example method of operating MDS 300 in accordance with an aspect of the present invention will now be described with reference to FIG. 7.

FIG. 7 is a flowchart of an example method 700 of operating MDS 300.

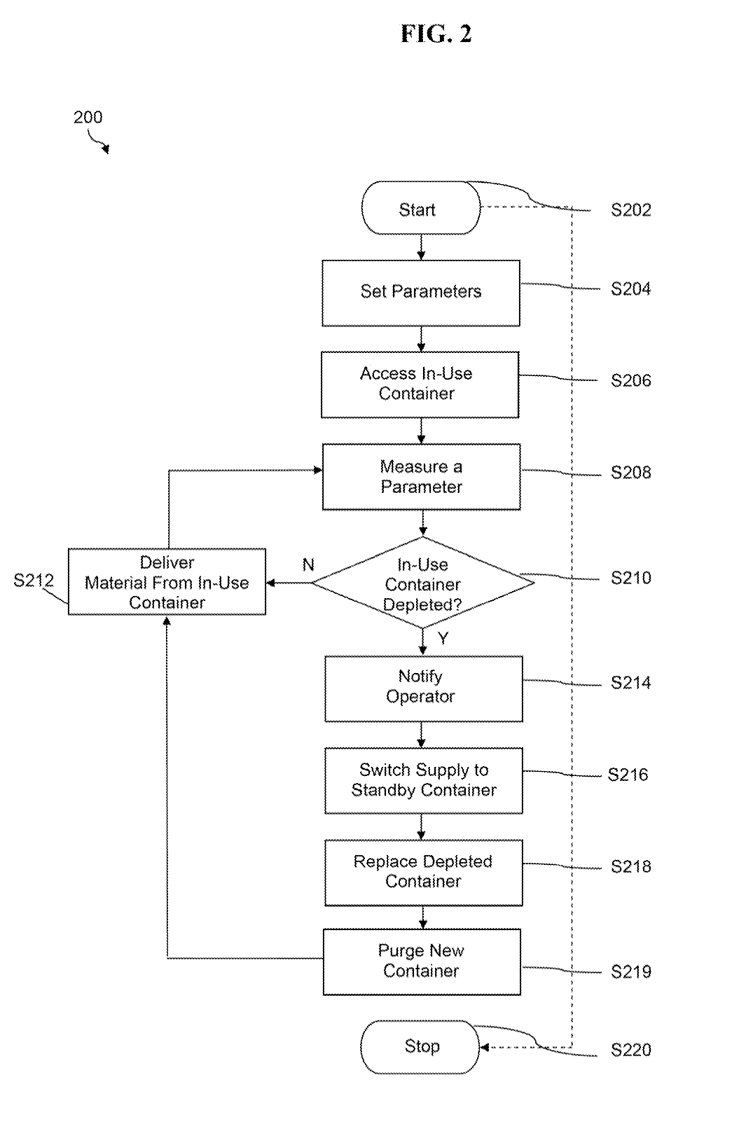

In operation, method 700 is similar to method 200 discussed above with reference to FIG. 2 up until step S219.

In method 700, after purge procedure is complete, the material within the newly installed container is compared with the material in the in-use container (S702). In this example, let container 118 be a newly installed container, whereas container 120 is the current in-use container. Here the material within container 118 is compared with the material within container 120, for example by way of comparing device 306 as discussed above with reference to FIGS. 3-6B.

It is then determined whether the material in container 118 is likely the same as the material in container 120 (S704). For example, if it is determined that signal 412 is less than a predetermined threshold as discussed above.

If it is determined that the material in container 118 is likely the same as the material in container 120, controller portion 301 may continue to deliver material to the material distribution system from container 120 (S212).

Alternatively, if it is determined that the material in container 118 is likely not the same as the material in container 120, then the operator of MDS 300 may be notified that the material in container 118 is likely not the correct material (S706). At this point, the operator may then install a new container (S218).

MDS 300 may continue to deliver material to the material distribution system from in-use container 120. The system operator may concurrently install a new container 118 having the correct material therein.

Process 700 may continue to provide an uninterrupted flow of material during this procedure. In essence, process 700 may continue uninterrupted. Process 700 may be terminated (S220) by controller portion 301 if one or more of any error conditions exist, including manual termination by the operator of MDS 300 by, for example, shutting down the system.

As discussed above, there may be situations where an incorrect material is stored within a container, which is about to be accessed by MDS 300. There may be instances wherein an operator of an MDS may inadvertently connect the wrong container to the MDS when switching out a depleted container. It is also possible that the supplier of full containers may have put the wrong material into a container, or may have mislabeled a container, thereby establishing another condition wherein the wrong material may become connected to an MDS. There may also be a situation wherein an operator may intentionally or accidentally override mechanical or other system interlocks and/or protection methods and thereby facilitate connection of the wrong material to an MDS. In any of these situations, wherein the wrong material is connected to an MDS, the MDS may eventually accesses the incorrect material and cause contamination of the system, damage to the system, contamination of downstream systems utilizing the material from the MDS.

In accordance with aspects of the present invention, if the wrong material is connected to an MDS, a controller will be able to detect the situation in order to warn a user before the MDS accesses the wrong material. In an example embodiment, a comparing device 306 is arranged to compare a parameter of a material from an in-use container with a parameter of a material from a stand-by container to determine whether the material in the stand-by container is likely the same as the material in the in-use container.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A controller for use in a material dispensing system having a first material inlet, a second material inlet, a distribution outlet, a first material container and a second material container, the first material container having a first container parameter and being operable to contain an amount of a first material, the second material container having a second container parameter and being operable to contain an amount of a second material, the first material container being operable to provide the first material to the first material inlet, the second material container being operable to provide the second material to the second material inlet, said controller comprising:
a device arranged to receive the first material and to receive the second material and operable to provide a first signal based on the first material and to provide a second signal based on the second material; and
an output device operable to provide an output signal based on the first signal and the second signal.

2. The controller of claim 1, further comprising an indicator operable to provide an indicator signal when the output signal is above a predetermined threshold.

3. The controller of claim 2, wherein said device comprises:
a first portion arranged to receive the first material and operable to provide a first signal based on the first material; and
a second portion arranged to receive the second material and operable to provide a second signal based on the second material.

4. The controller of claim 3,
wherein said first portion comprises a first resistor, and
wherein said second portion comprises a second resistor.

5. The controller of claim 4, further comprising:
a voltage source having a first node and a second node,
wherein said device further comprises a third resistor and a fourth resistor,
wherein said output device comprises a current meter,
wherein said first resistor comprises a first contact and a second contact,
wherein said second resistor comprises a third contact and a fourth contact,
wherein said third resistor comprises a fifth contact and a sixth contact,
wherein said fourth resistor comprises a seventh contact and an eighth contact,
wherein said current meter comprises a ninth contact and a tenth contact,
wherein said first contact is electrically connected to said third contact and said first node,
wherein said fifth contact is electrically connected to said seventh contact and said second node,
wherein said second contact is electrically connected to said sixth contact and said ninth contact, and
wherein said fourth contact is electrically connected to said eighth contact and said tenth contact.

6. The controller of claim 1, wherein said device comprises:
a first portion arranged to receive the first material and operable to provide a first signal based on the first material; and
a second portion arranged to receive the second material and operable to provide a second signal based on the second material.

7. The controller of claim 6,
wherein said first portion comprises a first resistor, and
wherein said second portion comprises a second resistor.

8. The controller of claim 7, further comprising:
a voltage source having a first node and a second node,
wherein said device further comprises a third resistor and a fourth resistor,
wherein said output device comprises a current meter,
wherein said first resistor comprises a first contact and a second contact,
wherein said second resistor comprises a third contact and a fourth contact,
wherein said third resistor comprises a fifth contact and a sixth contact,
wherein said fourth resistor comprises a seventh contact and an eighth contact,
wherein said current meter comprises a ninth contact and a tenth contact,
wherein said first contact is electrically connected to said third contact and said first node,
wherein said fifth contact is electrically connected to said seventh contact and said second node,
wherein said second contact is electrically connected to said sixth contact and said ninth contact, and
wherein said fourth contact is electrically connected to said eighth contact and said tenth contact.

9. The controller of claim 1, further comprising:
a voltage source having a first node and a second node,
wherein said device further comprises a third resistor and a fourth resistor,
wherein said output device comprises a current meter,
wherein said first resistor comprises a first contact and a second contact,
wherein said second resistor comprises a third contact and a fourth contact,
wherein said third resistor comprises a fifth contact and a sixth contact,
wherein said fourth resistor comprises a seventh contact and an eighth contact,
wherein said current meter comprises a ninth contact and a tenth contact,
wherein said first contact is electrically connected to said third contact and said first node,
wherein said fifth contact is electrically connected to said seventh contact and said second node,
wherein said second contact is electrically connected to said sixth contact and said ninth contact, and
wherein said fourth contact is electrically connected to said eighth contact and said tenth contact.

10. The controller of claim 1, further comprising an indicator operable to provide an indicator signal when the absolute value of the output signal is above a predetermined threshold.

11. A method of using a material dispensing system having a first material inlet, a second material inlet, a distribution outlet, a first material container and a second material container, the first material container having a first container parameter and being operable to contain an amount of a first material, the second material container having a second container parameter and being operable to contain an amount of a second material, the first material container being operable to provide the first material to the first material inlet, the second material container being operable to provide the second material to the second material inlet, said method comprising:
providing the first material to a device;
providing the second material to the device;
generating, with the device, a first signal based on the first material;
generating, with the device, a second signal based on the second material; and
outputting an output signal based on the first signal and the second signal.

12. The method of claim 11, further comprising providing an indicator signal when the output signal is above a predetermined threshold.

13. The method of claim 12,
wherein said providing the first material to the device comprises providing the first material to a first portion of the device, and
wherein said providing the second material to the device comprises providing the second material to a second portion of the device.

14. The method of claim 13,
wherein said providing the first material to a first portion of the device comprises providing the first material to a first resistor, and
wherein said providing the second material to a second portion of the device comprises providing the second material to a second resistor.

15. The method of claim 14,
wherein said providing the first material to a device further comprises providing the first material to the device including a voltage source, a third resistor and a fourth resistor, the voltage source having a first node and a second node,
wherein said outputting an output signal based on the first signal and the second signal comprises a outputting, with a current meter, the output signal based on the first signal and the second signal,
wherein the first resistor comprises a first contact and a second contact,
wherein the second resistor comprises a third contact and a fourth contact,
wherein the third resistor comprises a fifth contact and a sixth contact,
wherein the fourth resistor comprises a seventh contact and an eighth contact,
wherein the current meter comprises a ninth contact and a tenth contact,
wherein the first contact is electrically connected to the third contact and the first node,
wherein the fifth contact is electrically connected to the seventh contact and the second node,
wherein the second contact is electrically connected to the sixth contact and the ninth contact, and
wherein the fourth contact is electrically connected to the eighth contact and the tenth contact.

16. The method of claim 11,
wherein said providing the first material to the device comprises providing the first material to a first portion of the device, and
wherein said providing the second material to the device comprises providing the second material to a second portion of the device.

17. The method of claim 16,
wherein said providing the first material to a first portion of the device comprises providing the first material to a first resistor, and
wherein said providing the second material to a second portion of the device comprises providing the second material to a second resistor.

18. The method of claim 17, further comprising:
wherein said providing the first material to a device further comprises providing the first material to the device including a voltage source, a third resistor and a fourth resistor, the voltage source having a first node and a second node,
wherein said outputting an output signal based on the first signal and the second signal comprises a outputting, with a current meter, the output signal based on the first signal and the second signal,
wherein the first resistor comprises a first contact and a second contact,
wherein the second resistor comprises a third contact and a fourth contact,
wherein the third resistor comprises a fifth contact and a sixth contact,
wherein the fourth resistor comprises a seventh contact and an eighth contact,
wherein the current meter comprises a ninth contact and a tenth contact,
wherein the first contact is electrically connected to the third contact and the first node,
wherein the fifth contact is electrically connected to the seventh contact and the second node,
wherein the second contact is electrically connected to the sixth contact and the ninth contact, and
wherein the fourth contact is electrically connected to the eighth contact and the tenth contact.

19. The method of claim 11, further comprising:
wherein said providing the first material to a device further comprises providing the first material to the device including a voltage source, a third resistor and a fourth resistor, the voltage source having a first node and a second node,
wherein said outputting an output signal based on the first signal and the second signal comprises a outputting, with a current meter, the output signal based on the first signal and the second signal,
wherein the first resistor comprises a first contact and a second contact,
wherein the second resistor comprises a third contact and a fourth contact,
wherein the third resistor comprises a fifth contact and a sixth contact,
wherein the fourth resistor comprises a seventh contact and an eighth contact,
wherein the current meter comprises a ninth contact and a tenth contact,
wherein the first contact is electrically connected to the third contact and the first node,
wherein the fifth contact is electrically connected to the seventh contact and the second node,
wherein the second contact is electrically connected to the sixth contact and the ninth contact, and
wherein the fourth contact is electrically connected to the eighth contact and the tenth contact.

20. The method of claim 11, further comprising providing an indicator signal when the absolute value of the output signal is above a predetermined threshold.
